(19) United States
(12) Patent Application Publication
(10) Pub. No.: US 2011/0001901 A1
(43) Pub. Date: Jan. 6, 2011

(54) DUAL LIGHTGUIDE

(76) Inventors: Jeffrey L. Solomon, Vadnais Heights, MN (US); Gary T. Boyd, Woodbury, MN (US); James W. Laumer, White Bear Lake, MN (US); Brian A. Kinder, Woodbury, MN (US); L. Peter Erickson, Minneapolis, MN (US)

Correspondence Address: 3M INNOVATIVE PROPERTIES COMPANY, PO BOX 33427, ST. PAUL, MN, 55133-3427, US

(21) Appl. No.: 12/744,534

(22) PCT Filed: Dec. 3, 2008
(86) PCT No.: PCT/US08/85350

§ 371 Date: Sep. 13, 2010

Related U.S. Application Data
(60) Provisional application No. 60/992,476, filed on Dec. 5, 2007.

(51) Int. Cl. G02F 1/1335; F21V 7/22; G02B 6/04

(52) U.S. Cl. 349/65; 362/616; 362/606; 362/611; 362/613; 264/1.28

(57) ABSTRACT

A backlight subsystem includes first and second lightguides separated by an interfacial layer. The first lightguide has an output surface oriented toward an associated first illumination field, a back surface, and at least one light input edge. The second lightguide has output surface oriented toward an associated second illumination field, a back surface, and at least one light input edge. An interfacial layer is arranged between the back surfaces of the first lightguide and the second lightguide. The interfacial layer is substantially optically non-absorbing and may be predominately optically transmissive or predominately optically reflective.

### FIELD OF THE INVENTION

The present disclosure is directed to a dual lightguide and methods of making the dual lightguide.

### BACKGROUND

Flat panel displays are used in a variety of applications ranging from relatively large devices including computer monitors and televisions, to small, low-power devices such as cell telephones and wristwatches. Flat panel displays typically use liquid crystals, or other optically active materials, that require a backlight. For display applications, it is desirable that backlights generate bright, uniform illumination with few visible defects. In addition to becoming more prevalent, liquid crystal displays (LCDs) are becoming thinner as the manufacturers of electronic devices incorporating LCDs strive for smaller package sizes.

There is a need for enhanced lightguides for backlights providing lighting for optical displays, including displays used in small size, low-cost and/or low-power applications. The present invention fulfills these and other needs, and offers other advantages over the prior art.

### SUMMARY

Embodiments of the invention are directed to backlight subsystems, methods for making backlight subsystems, and devices and systems incorporating backlight subsystems. One embodiment of the invention is directed to a backlight subsystem that includes first and second lightguides. The first lightguide has an output surface oriented toward an associated first illumination field, a back surface, and at least one light input edge. The second lightguide has output surface oriented toward an associated second illumination field, a back surface, and at least one input edge. An interfacial layer is arranged between the back surfaces of the first lightguide and the second lightguide. The interfacial layer is substantially optically non-absorbing and may be predominately optically transmissive or predominately optically reflective.

Another embodiment of the invention involves a method of making a lightguide subsystem. An interfacial layer is arranged between the back surfaces of a first light guide and a second lightguide. The first lightguide and the second lightguide each have an output surface, a back surface, and at least one input edge. The interfacial layer is substantially optically non-absorbing. Arranging the subsystem components may be performed using a web-based roll to roll process. For example, one or more of the first lightguide, the second lightguide, and the interfacial layer may be processed as a web. According to one aspect, the first and second lightguides are molded into optical material deposited on an interfacial layer web.

The above summary of the present invention is not intended to describe each embodiment or every implementation of the present invention. Advantages and attainments, together with a more complete understanding of the invention, will become apparent and appreciated by referring to the following detailed description and claims taken in conjunction with the accompanying drawings.

### BRIEF DESCRIPTION OF THE DRAWINGS

FIGS. 1A and 1B illustrate exploded and unexploded cross sections, respectively, of a backlight subsystem according to embodiments of the invention;

FIG. 2A illustrates a backlight subsystem having a reflective interfacial layer in accordance with embodiments of the invention;

FIG. 2B illustrates the operation of a backlight subsystem incorporating a transmissive interfacial layer in accordance with embodiments of the invention;

FIG. 3 shows a backlight subsystem having an interfacial layer that includes an air gap in accordance with embodiments of the invention;

FIG. 4 is a cross sectional view of a backlight subsystem having one lightguide that is thicker than a second lightguide in accordance with embodiments of the invention;

FIGS. 5A and 5B illustrate a backlight subsystem having lightguides of various dimensions in accordance with embodiments of the invention;

FIGS. 6-10 illustrate various light source configurations that may be used in conjunction with dual lightguides in accordance with various embodiments of the invention;

FIGS. 11 and 12 illustrate backlight subsystems with lightguides having structured surface features that may be useful for light extraction or diffusion in accordance with embodiments of the invention;

FIG. 13 depicts a backlight subsystem incorporating a multi-layer lightguide in accordance with embodiments of the invention;

FIGS. 14-18 diagrammatically illustrate processes for fabricating dual lightguides in accordance with embodiments of the invention; and

FIGS. 19-20 are block diagrams of various devices that may incorporate dual lightguide subsystems in accordance with embodiments of the invention.

While the invention is amenable to various modifications and alternative forms, specifics thereof have been shown by way of example in the drawings and will be described in detail. It is to be understood, however, that the intention is not to limit the invention to the particular embodiments described. On the contrary, the intention is to cover all modifications, equivalents, and alternatives falling within the scope of the invention as defined by the appended claims.

### DETAILED DESCRIPTION

In the following description of the illustrated embodiments, references are made to the accompanying drawings forming a part hereof, and in which are shown by way of illustration, various embodiments by which the invention may be practiced. It is to be understood that other embodiments may be utilized, and structural and functional changes may be made without departing from the scope of the present invention.

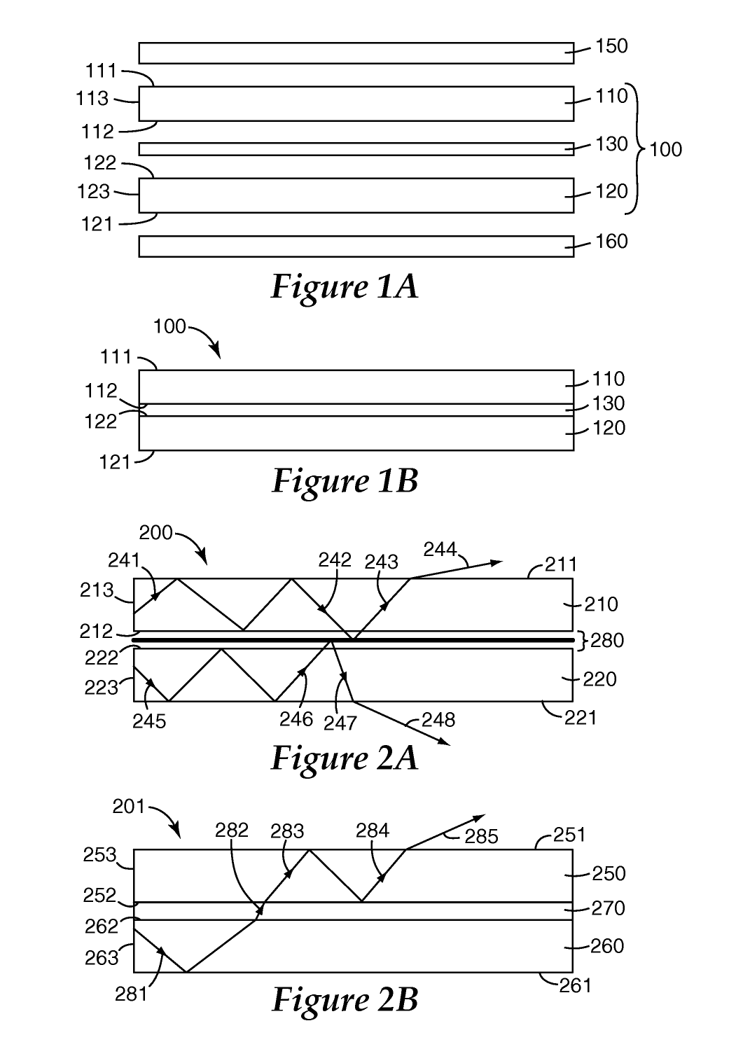

Embodiments of the invention involve a backlight subsystem including at least two lightguides and a substantially optically non-absorbing interfacial layer which is disposed between the two lightguides. FIGS. 1A and 1B illustrate exploded and unexploded cross sections, respectively, of a backlight subsystem 100 according to embodiments of the invention. The subsystem 100 includes a first lightguide 110 having an output surface 111, a back surface 112, and at least one input edge 113. A second lightguide 120 includes an output surface 121, a back surface 122, and at least one input edge 123. As illustrated in FIGS. 1A and 1B, the back surfaces 112, 122 of the lightguides 110, 120 are proximate the interfacial layer 130. The output surfaces 111, 121 are nearest to an associated illumination field 150. 160. Although light may emerge or “leak” from the back surfaces 112, 122, the output surfaces 111, 121 are so designated because they are oriented toward the associated illumination fields 150, 160. The lightguides 110, 120 may be made of thin, flexible material which is amenable to roll to roll processing, thus reducing the cost of the dual lightguide.

The lightguides 110, 120 are arranged to emit light in different directions to illuminate first and second illumination fields 150, 160 or first and second portions of a single illumination field. The illumination field or fields 150, 160 may include any combination of general lighting, active displays, such as liquid crystal displays (LCDs), or passive displays, such as graphics, indicators, signage, or other illuminated conveyances. For example, in one implementation, the backlight subsystem 100 can be arranged between first and second LCD display panels 150, 160. The first lightguide 110 is oriented relative to the first display panel 150 so that light is emitted from the output surface 111 of the first lightguide 110 toward the first display panel 150. The second lightguide 120 is oriented relative to the second display panel 160 so that light is emitted from the output surface 121 of the second lightguide 120 toward the second display panel 160.

The first and second lightguides 110, 120 may be formed of a rigid or flexible material which is substantially optically transparent. Exemplary materials include glass or polymeric materials such as cyclic olefin co-polymers (COC), polyester (e.g., polyethylene naphthalate (PEN), polyethylene terephthalate (PET), and the like), polyacrylate, polymethylmethacrylate (PMMA), polycarbonate (PC), or any other suitable polymeric material. In some embodiments, dual light guide subsystem 100 is thin enough to be capable of bending without damage to a radius of curvature down to about 100 mm, or down to about 50, or about 30, or about 15, or about 10, or about 5 mm.

Additional films may be interposed between the output surface of a lightguide 110, 120 and its associated display device 150, 160. These additional films include brightness enhancement films, diffusers, retarders, absorbers, or films with other useful optical functions.

The interfacial layer, which may have multiple sub-layers, is substantially optically non-absorbing and may be predominately optically reflective or predominately optically transmissive. The optical index of the interfacial layer may be chosen to permit or avoid total internal reflection (TIR), according to the optical effects desired. The two lightguides may be of different sizes and optical properties, such as index of refraction, and their light extraction zones may differ in size and intensity of light output.

FIG. 2A illustrates a backlight subsystem 200 having a reflective interfacial layer 230. A light ray 241 entering via the input edge 213 of the first lightguide 210 is propagated down the first lightguide 210 by total internal reflection (TIR). If the light ray 242 emerges or “leaks” from the back surface 212 of the first lightguide 210, the ray 243 is reflected back into the lightguide 210 and may continue propagating until the ray 244 eventually is emitted from the output surface 211.

Similarly, a light ray 245 entering via the input edge 223 of the second lightguide 220 is propagated down the second light guide 220. If the light ray 246 escapes from the back surface 222 of the second lightguide 220, the ray 247 is reflected and reenters the second lightguide 220. The reentrant ray 247 propagates down the lightguide until it escapes from the output surface 221 of the second lightguide 220.

The interfacial layer 230 may be a specular or diffuse reflector. In various embodiments, the interfacial layer 230 may comprise a metallic layer or a polymeric reflector and may comprise a multi-layer polymeric reflector, such as enhanced specular reflector (ESR) available from 3M, St. Paul, Minn. The interfacial layer may comprise a reflective polarizer, which transmits one polarization of light and reflects another polarization of light. The interfacial layer 230 may include one or more adhesive sub-layers.

In some embodiments, the backlight subsystem includes an interfacial layer that is predominately optically transmissive. The operation of a backlight subsystem 201 incorporating a transmissive interfacial layer 270 is illustrated in FIG. 2B. A light ray 280 entering via the input edge 263 of the second lightguide 260 is propagated down the second lightguide 260 by total internal reflection. If the light ray escapes from the back surface 262 of the second lightguide 260, the ray 282 is transmitted through the interfacial layer 270, and may be transmitted through the back surface 252 into the first lightguide 250. In the first lightguide 250, the light ray 284 may continue propagation down the first lightguide 250 by total internal reflection until it is emitted from the output surface 251 of the first light guide 250.

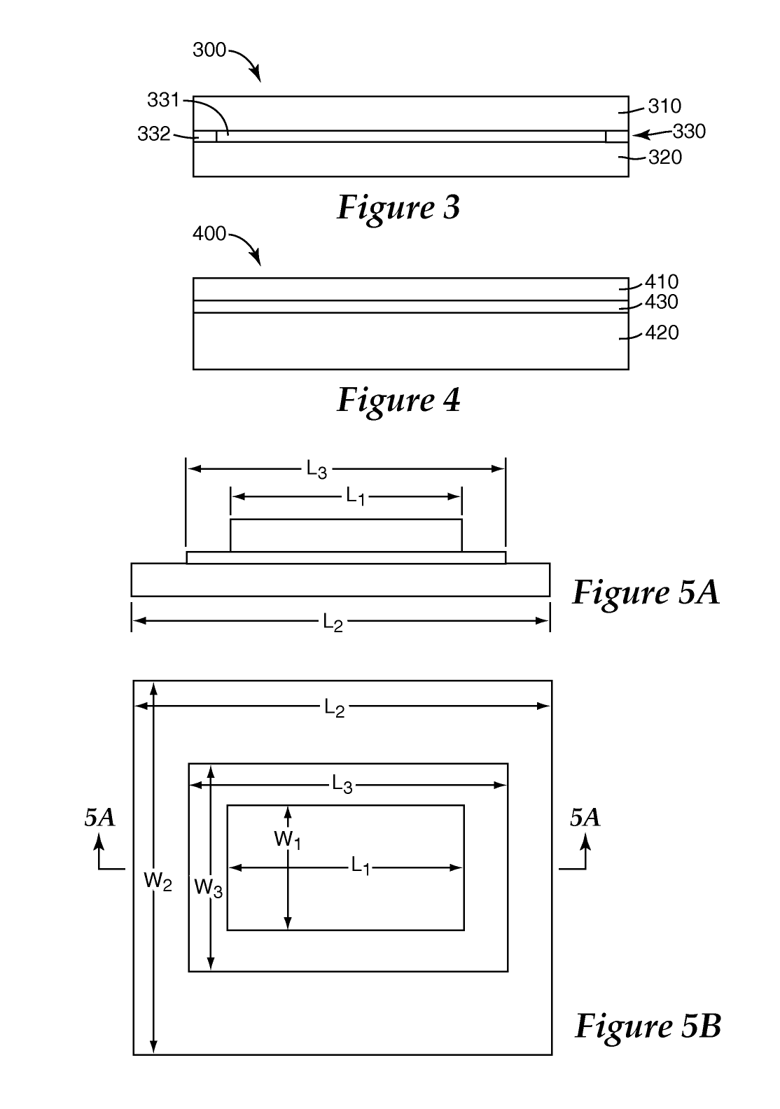

The interfacial layer may comprise an optically transmissive adhesive used to join the first lightguide and the second lightguide. The adhesive can be activated by pressure or temperature and/or curable by optical radiation. For example, the interfacial layer may comprise a pressure sensitive adhesive, a thermally curable resin, or a UV curable resin. As illustrated in the cross sectional view illustrated in FIG. 3, the interfacial layer 330 may comprise an air gap 331 and a rim adhesive 332 arranged between the first and second lightguides 310, 320.

The first and second lightguides and the interfacial layer need not have the same thickness. As illustrated by the backlight subsystem 400 of FIG. 4, one of the lightguides 420 may be thicker than the other lightguide 410 and both of the lightguides 410, 420 may be thicker than the interfacial layer 430.

The lightguides may be rigid or flexible. If flexible, the thickness and/or other material and/or physical properties of the lightguides may be selected to allow the dual lightguide subsystem to retain substantial flatness through prevention or reduction of curling and/or wrinkling of the lightguides after they are joined. For example, the material properties of one lightguide may be selected to have a tendency to balance the curl in a direction opposing that of the other lightguide. When at least one of the dual lightguide components is curled or too flexible for use, such dual systems may provide added lightguide rigidity and flatness, when the second lightguide component provides an opposite balancing curl, or is of greater rigidity, due to its thickness or to the material used, such as glass plate.

The first and second lightguides and/or the interfacial layer may or may not be completely coextensive. For example, in one embodiment, the first lightguide may have a length and/or width less than the length and/or width of the second lightguide. This embodiment is illustrated in the cross section and top views of FIGS. 5A and 5B, respectively. As illustrated in FIGS. 5A and 5B, the length and/or width of the first lightguide, L₁, W₁, may be different from the length and/or width of the second lightguide, L₂, W₂, and may also be different from the length and/or width L₃, W₃, of the interfacial layer.

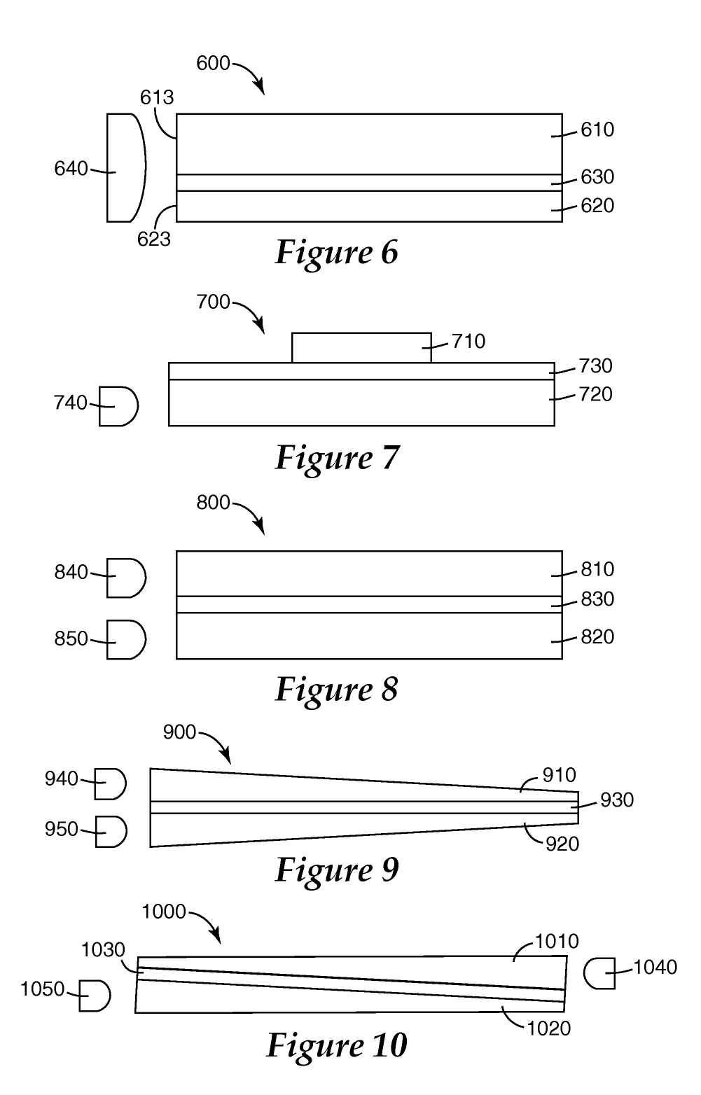

FIGS. 6-10 illustrate various light source configurations that may be used with a dual lightguide subsystem. The subsystem may include any suitable type of light source such as a fluorescent lamp or a light emitting diode (LED). Furthermore, the light source may include a plurality of discrete light sources such as a plurality of discrete LEDs. It will be appreciated that the lightguides may have more than one input edge, and that single or multiple light sources may be positioned relative to one or more of the input edges.

For example, as illustrated in FIG. 6, the light source of a backlight subsystem 600 may include a single light source 640 positioned proximate to the input edges 613, 623 of the lightguides 610, 620 which are separated by an interfacial layer 630.

In another implementation of a backlight subsystem 700, illustrated in FIG. 7, a single light source 740 is positioned to provide light to one of the lightguides 720. A transmissive interfacial layer 730 separating the lightguides 710, 720 allows for illumination of the other lightguide 710 through the back surface of the lightguide 720 which is illuminated by the light source 740.

FIG. 8 illustrates yet another configuration of a backlight subsystem 800, wherein each of the lightguides 810, 820 is associated with a separate light source 840, 850. The subsystem 900 of FIG. 9 illustrates separate light sources 940, 950 arranged proximate an input edge of wedge-type lightguides 910, 920. The lightguides may be arranged so that the direction of light propagation in one lightguide is different from the direction of light propagation in the other lightguide. This configuration is illustrated by the backlight subsystem 1000 of FIG. 10. A separate light source 1040, 1050, is associated with each of the wedge lightguides 1010, 1020 which are separated by a transmissive or reflective interfacial layer 1030. The direction of light propagation in the first light guide 1010 opposes the direction of light propagation in the second light guide 1020. The arrangement illustrated in FIG. 10 may be useful for maintaining a substantially constant overall thickness of the backlight subsystem 1000.

One or both of the lightguides may have at least one structured surface. For example, the structured surface can provide light extraction features or surface features for light diffusion or diffraction. One or both of the lightguides may include extraction or surface features on one or both of their output and back surfaces. The extraction features of one lightguide maybe the same as or different from those of another lightguide. For example one lightguide may have extraction features comprising v-grooves and the other lightguide may have extraction features comprising lenslets. Furthermore, the extraction features on one surface of a lightguide may be the same as or different from the extraction features on another surface of the same lightguide.

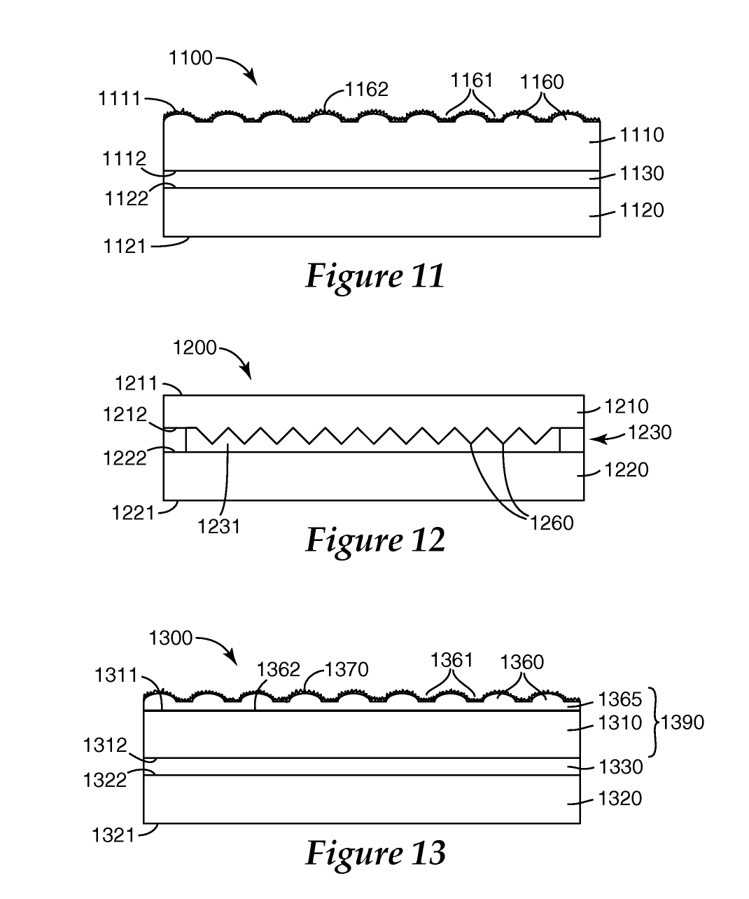

FIGS. 11 and 12 illustrate dual lightguide subsystems 1100, 1200 that include extraction features 1160, 1260 on at least one lightguide surface. The subsystem 1100 of FIG. 11 illustrates extraction features 1160 disposed on the output surface 1111 of one of the lightguides 1110. Extraction features may alternatively or additionally be disposed on the back surface 1112 of the lightguide 1110 and/or may be disposed on the output surface 1121 and/or the back surface 1122 of the other lightguide 1120. In general, the spacing between neighboring light extractors 1160 can be different at different locations of the lightguide 1110. Furthermore, the shape, respective heights, and/or the size of the light extractors 1160 can be different for different light extractors. Such variation can be useful in controlling the amount of light extracted at different locations of the lightguide 1110. If desired, light extractors 1160, 1260 can be designed and arranged such that light is extracted according to a desired light extraction pattern over the output surface of the lightguide 1110.

In the exemplary embodiment shown in FIG. 11, light extractors 1160 form a plurality of discrete light extractors. In some applications, light extractors 1160 may form a continuous profile, such as a sinusoidal profile, that may extend, for example, along the y- and z-axes.

Light extractors 1160 and land area 1161 may have a structured surface including light diffusion features 1162 for scattering a fraction of light incident on the diffusion features. Diffusion features 1162 can assist with extracting light from the light guide 1110 and can improve uniformity of the intensity of light that propagates inside light guide 1110 by, for example, scattering the light laterally along the y-axis.

FIG. 11 shows convex lenslets as light extractors 1160, wherein each lenslet forms a bump on surface of the lightguide 1110 separated by a land area 1161. In general, light extractors 1160 can have any shape that can result in a desired light extraction. For example, light extractors 1160 can include concave structures forming depressions in surface of the lightguide 1110, convex structures such as hemispherical convex lenslets, prismatic structures, sinusoidal structures, or any other shape with linear or nonlinear facets or sides that may be suitable in providing a desired light extraction pattern.

The subsystem of FIG. 1200 illustrates a structured surface on the back surface 1212 of one of the lightguides 1210. In this embodiment, the structured surface involves v-grooves 1260 which facilitate light extraction and/or diffusion. The interfacial layer 1230 in this example comprises an air gap 1231 and the v-grooves 1260 are embedded in the air gap 1231 between the first and second lightguides 1210, 1220.

The lightguides of the backlight subsystem may be single layer or unitary lightguides as illustrated in FIGS. 11 and 12, or may be multi-layer lightguides which include two or more layers. An exemplary multi-layer lightguide is illustrated in FIG. 13. Subsystem 1300 includes a first and second lightguides 1310, 1320. In this example, one lightguide 1310 is a multi-layer structure, although in some implementations, both lightguides may include multiple layers.

Lightguide 1390 includes a light guiding first layer 1310 in contact with a second layer 1365. In some embodiments, substantially an entire surface 1311 of the first layer 1310 is in contact with substantially an entire surface 1362 of the second layer 1365. The second layer 1365 includes a plurality of light extractors 1360 on the surface opposite the first layer 1310 which are capable of extracting light that propagates in the lightguide 1390.

As previously illustrated in FIG. 11, the extraction features 1360 may additionally include diffusion features 1370. The diffusion features 1370 can be formed in or on the surface of the second layer 1365, for example, by coating or other processes. As another example, diffusion features 1370 can be formed while making light extractors 1360 by any suitable process, such as microreplication, embossing, or any other method that can be used to simultaneously or sequentially form light extractors 1360 and diffusion features 1370.

The neighboring light extractors 1360 can be separated by a land area 1361 having an average thickness “d.” In some embodiments, the average thickness of land area 1361 is no greater than about 20, or about 15, or about 10, or about 5, or about 2 microns.

The light guiding layer 1310 has a first index of refraction n₁ and second layer 1365 has a second index of refraction n₂ where n₁ and n₂ can, for example, be indices of refraction in the visible range of the electromagnetic spectrum. In one embodiment of the invention, n₁ is less than or equal to n₂. In some applications, n₁ is less than or equal to n₂ for both S-polarized and P-polarized incident light. In some embodiments, at least one of light guiding layer 1310 and second layer 1365 is isotropic in refractive index. In some applications, both layers are isotropic.

The thickness of the lightguiding layer 1310 may be thicker than the thickness of the second layer 1365. For example, the average thickness of the light guiding layer 1310 may be at least 5, or 10, or 20, or 40 times the maximum thickness of the second layer 1365.

In some embodiments, the average thickness of the light guiding layer 1310 is no greater than about 1000, or about 700, or about 500, or about 400, or about 250, or about 200 microns. In some embodiments, the maximum thickness of the second layer 1365 is no greater than about 100, or about 50, or about 15 microns. In some embodiments, light guiding layer 1310 is self-supporting while the second layer 1365 is not. Here, “self-supporting” refers to a film that can sustain and support its own weight without breaking, tearing, or otherwise being damaged in a manner that would make it unsuitable for its intended use.

Additional description of multi-layer lightguides is provided in commonly owned U.S. Patent Application identified by Attorney Docket No. 60832US002, filed May 31, 2006.

The dual lightguide subsystems described herein may be formed by arranging an interfacial layer between first and second lightguides. The first and second lightguides are arranged so that their back surfaces are proximate the interfacial layer. Pick and place processes may be used for making dual lightguide subsystems having one or more rigid components, such as injection molded lightguides. The use of flexible lightguide materials advantageously allows for web-based or roll-to-roll manufacturing processes, which may provide increased speed and reduced manufacturing costs.

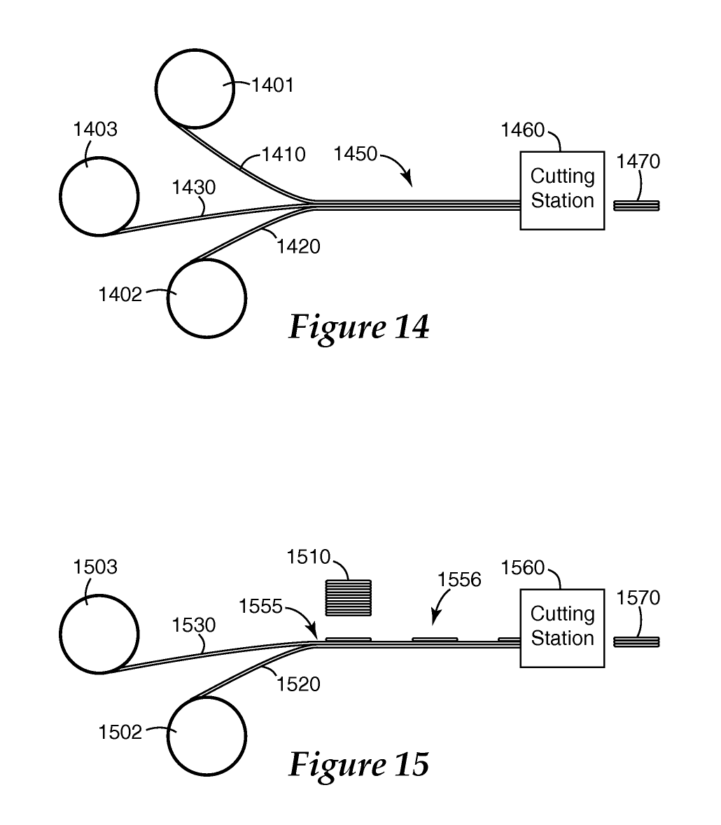

FIG. 14 illustrates a roll-to-roll manufacturing process for making dual lightguide subsystems described herein. In the process illustrated in FIG. 14, the first lightguide layer 1410, second lightguide layer 1420, and the interfacial layer 1430 comprise flexible webs that can be stored on input rolls 1401, 1402, and 1403, respectively. The first lightguide layer 1410, second lightguide layer 1420, and interfacial layer 1430 are unwound from the input rolls 1401, 1402, 1403, and are brought together, either simultaneously or sequentially, and are joined, such as by lamination, to form a dual lightguide web 1450. Cutting station 1460 cuts the dual lightguide web 1450 into individual dual lightguide subsystems 1470.

In the implementation illustrated in FIG. 15, the second lightguide 1520 and the interfacial layer 1530 are processed in web form. A plurality of first lightguides are processed as discrete components 1510. The process in FIG. 15 provides for the use of one lightguide made of a relatively rigid material used in conjunction with a flexible lightguide.

The second lightguide 1520 and the interfacial layer 1530 comprise webs disposed on input rolls 1502, 1503. The second lightguide layer 1520 and the interfacial layer 1530 are unwound from input rolls 1502, 1503 and are brought together and joined. The discrete first lightguides 1510 are arranged on the subassembly web 1555 comprising the joined interfacial layer/second light guide. Appropriate registration processes may be necessary to ensure that the three layers are accurately registered. The first lightguides 1510 and are joined to the interfacial layer 1530. A cutting station 1560 cuts the dual lightguide web 1556 into individual dual lightguide subsystems 1570. In an alternate embodiment, the discrete first lightguides may be arranged on the interfacial layer prior to the interfacial layer being brought into contact with the second lightguide layer.

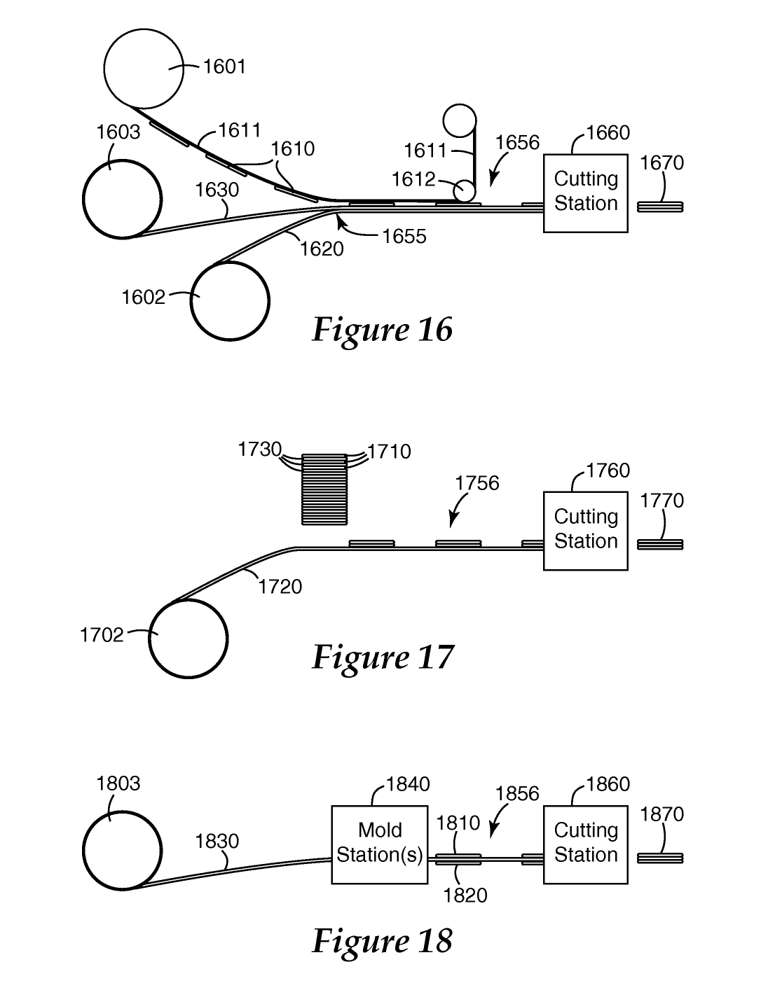

In some configurations, as shown in FIG. 16, a plurality of discrete lightguides 1610 are supported on a support web 1611 to facilitate roll-to-roll processing. The discrete first lightguides 1610 and support web 1611 are disposed on input roll 1601. The second lightguide layer 1620 and the interfacial layer 1630 are configured as webs disposed on input rolls 1602, 1603. The second lightguide layer 1620 and the interfacial layer 1630 are brought together and joined. The support web 1611 having the discrete first lightguides 1610 disposed thereon brings the discrete first lightguides 1610 into contact with subassembly web 1655 which comprises the joined interfacial layer/second light guide. The first lightguides 1610 are joined to the interfacial layer 1630 and the support web 1611 is removed by a peel roller 1612. A cutting station 1660 cuts the dual lightguide web 1656 into individual dual lightguide subsystems 1670. The order of processing may be altered. For example, the discrete first light guides may be attached to the interfacial layer prior to attachment of the second lightguide layer.

In yet another implementation, both the first lightguide and the interfacial layer may be discrete components and the second lightguide may be processed as a web. As shown in FIG. 17, the second lightguide web 1720 is stored on an input roll 1702. As the second lightguide web 1720 is unwound from roll 1702, the discrete interfacial layer and first lightguide components 1730, 1710, which may or may not be joined together, are arranged on second lightguide web 1720. If not previously joined, the first lightguides 1710 and the interfacial layers 1730 are joined together and the interfacial layers 1720 are joined to the second lightguide web 1720. A cutting station 1760 cuts the dual lightguide web 1756 into individual dual lightguide subsystems 1770

In another approach, the first and second lightguides may be formed on the interfacial layer as illustrated in FIG. 18. The interfacial layer 1830 is disposed on input roll 1803. As the interfacial layer 1830 is unwound from the input roll 1803, it passes through a mold station 1840. In the mold station 1840, optical materials are deposited on both sides of the interfacial layer 1830. The optical materials, which may be thermally or UV curable materials, are molded on the interfacial layer 1830 to form the first and second lightguides 1810, 1820. A cutting station 1860 cuts the dual lightguide web 1856 into individual dual lightguide subsystems 1870.

In any of the manufacturing processes described above, the order of processing the various web or discrete components may be altered. In addition, instead of the various web-based components being stored on input rolls, these components may alternatively come directly from a previous manufacturing process without any intermediate storage.

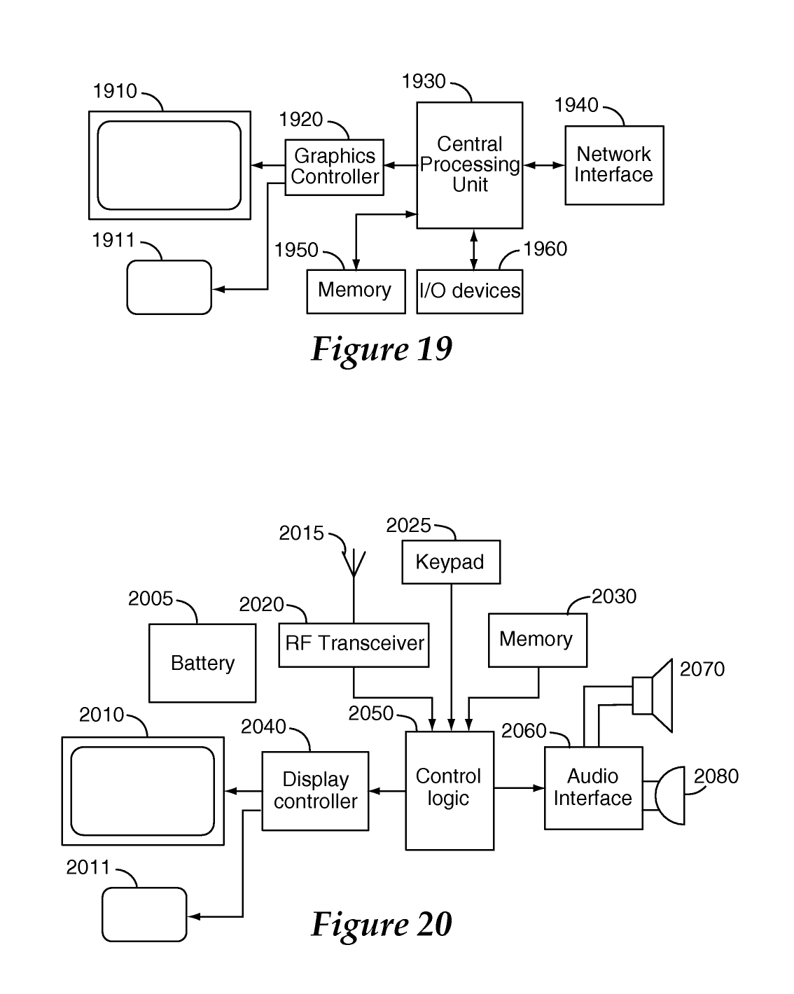

FIGS. 19 and 20 are block diagrams of exemplary devices incorporating dual displays illuminated by dual lightguides in accordance with embodiments of the present invention. In addition to the exemplary devices described below, many other applications for displays incorporating dual lightguide subsystems as described herein exist and will be readily apparent to the skilled practitioner.

FIG. 19 shows basic components of a handheld, tablet, laptop, or desktop computer having first and second displays 1910, 1911 illuminated by a backlight incorporating a dual lightguide as described in the examples provided above. The computer includes a central processing unit 1930 coupled to an input device 1960 such as a keyboard, mouse, joystick or other pointing device. Memory storage 1950 may include RAM, ROM, disc drives or flash memory modules which can be used for program and/or data storage. A graphics controller 1920 controls a primary LCD display 1910 and a secondary display 1911, e.g., logo display. Network connectivity for the computer may be provided through a wired or wireless network module 1940.

A cellular telephone incorporating dual displays illuminated by a dual lightguide subsystem in accordance with embodiments of the invention is illustrated in FIG. 20. The cellular telephone includes an RF transceiver 2020 coupled to an antenna 2015 configured to transmit and receive data and control signals to and from a base station operating in a cellular network. Data received via the transceiver 2020 is demodulated and converted to audio via the cell phone control logic 2050. Voice data is presented to a user through an audio interface 2060 coupled to a speaker 2070. A microphone 2080 transduces voice to electrical signals which are then further processed by the control logic 2050 and the transceiver 2020 prior to output via the antenna 2015. The cellular telephone receives input from the user through a keypad 2025 and may also have memory 2030 for storing user information and is powered by a rechargeable battery 2005.

The cellular telephone includes dual displays 2010, 2011 controlled by the display controller 2040. For example, a first display 2010 may be a primary display providing the display portion of a general user interface for the telephone. A secondary display 2011 may be arranged on the front of a flip-type cellular phone to display the time, date, and/or caller identification information.

The foregoing description of the various embodiments of the invention has been presented for the purposes of illustration and description. It is not region intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A backlight subsystem, comprising:
a first lightguide having an output surface, a back surface, and at least one input edge;
a second lightguide having an output surface, a back surface, and at least one input edge; and
an interfacial layer arranged between the first lightguide and the second lightguide.

2. The subsystem of claim 1, wherein the interfacial layer has first and second major surfaces and the first surface of the interfacial layer is proximate the back surface of the first lightguide and the second surface of the interfacial layer is proximate the back surface of the second lightguide.

3. The subsystem of claim 1, wherein the interfacial layer is predominately optically transmissive or predominately optically reflective.

4. The subsystem of claim 1, wherein the interfacial layer is optically transmissive and optically reflective.

5. The subsystem of claim 1, wherein the interfacial layer is substantially optically non-absorbing.

6. The subsystem of claim 1, wherein the interfacial layer comprises an air gap.

7. The subsystem of claim 1, wherein the interfacial layer comprises a polymeric material.

8. The subsystem of claim 1, wherein the interfacial layer comprises a metallic material.

9. The subsystem of claim 1, wherein the interfacial layer comprises a reflective polarizer.

10. The subsystem of claim 1, wherein the interfacial layer comprises a specular reflector.

11. The subsystem of claim 1, wherein the interfacial layer comprises a diffuse reflector.

12. The subsystem of claim 1, wherein the interfacial layer comprises an adhesive.

13. The subsystem of claim 1, wherein a thickness of the first lightguide is different from a thickness of the second lightguide.

14. The subsystem of claim 1, wherein a length or width of the first lightguide is different from a length or width of the second lightguide.

15. The subsystem of claim 1, wherein one or both of the first lightguide and the second lightguide include extraction features.

16. The subsystem of claim 15, wherein the extraction features are v-grooves.

17. The subsystem of claim 1, wherein one or both of the first lightguide and the second lightguide include light diffusion features.

18. The subsystem of claim 16, wherein diffusion features are lenslets.

19. The subsystem of claim 1, wherein the first lightguide is a multi-layer structure comprising:
a light guiding layer; and
a layer having extraction features.

20. The subsystem of claim 19, the first lightguide and the second lightguide are multi-layer lightguides, each of the multi-layer lightguides comprising a light guiding layer and a layer having extraction features.

21. The subsystem of claim 1, wherein one or both of the first lightguide and the second lightguide are adhered to the interfacial layer.

22. The subsystem of claim 1, wherein one or more of the back surface of the first lightguide, the output surface of the first lightguide, the back surface of the second lightguide, and the output surface of the second lightguide is a structured surface.

23. The subsystem of claim 1, wherein one or both of material properties and physical properties of the first and second lightguide are balanced to retain substantial flatness of the lightguides.

24. The subsystem of claim 1, further comprising a light source arranged to input light into at least one of the input edge of the first lightguide and the input edge of the second lightguide.

25. The subsystem of claim 1, further comprising a light source arranged to input light into the input edge of one of the first lightguide and the second lightguide.

26. The subsystem of claim 1, further comprising a light source arranged to input light into both the input edge of the first lightguide and the input edge of the second lightguide.

27. The subsystem of claim 1, further comprising:
a first light source arranged to input light into the input edge of the first lightguide; and
a second light source arranged to input light into the input edge of the second lightguide.

28. The subsystem of claim 1, wherein one or more of the first lightguide, the second lightguide, and the interfacial layer are flexible.

29. A method of making a lightguide subsystem, comprising arranging an interfacial layer between a first light guide having an output surface, a back surface, and at least one input edge and a second lightguide having an output surface, a back surface, and at least one input edge, wherein the interfacial layer is substantially non-absorbing and is proximate the back surfaces of the first lightguide and the second lightguide.

30. The method of claim 29, further comprising adhering at least one of the first lightguide and the second lightguide to the interfacial layer.

31. The method of claim 29, wherein the interfacial layer comprises a pressure or thermally sensitive adhesive.

32. The method of claim 29, wherein the interfacial layer comprises a thermally or UV curable material.

33. The method of claim 29, further comprising laminating at least one of the first lightguide and the second lightguide to the interfacial layer.

34. The method of claim 28, further comprising forming one or both of the first and second lightguides.

35. The method of claim 34, wherein forming one or both of the lightguides comprises forming one or both of the lightguides as flexible films.

36. The method of claim 34, wherein forming one or both of the lightguides comprises forming one or both of the lightguides by injection molding.

37. The method of claim 29, wherein forming one or both of the first and second lightguides comprises forming a light guiding layer and forming v-grooves in the light guiding layer.

38. The method of claim 29, wherein forming one or both of the first and the second lightguides comprises forming extraction features on one or both of the first and the second lightguides.

39. The method of claim 38, wherein forming the extraction features comprises depositing the extraction features

40. The method of claim 38, wherein forming the extraction features, comprises:
depositing a layer of optical material on a light guiding layer; and
forming the extraction features in the layer of optical material.

41. The method of claim 40, wherein the forming the extraction features in the optical material layer comprises:
embossing extraction shapes into the layer of optical material; and
curing the embossed layer of optical material.

42. The method of claim 40, wherein:
depositing the layer of optical material comprises depositing a UV or thermally curable resin; and
forming of extraction features in the optical material layer comprises microreplicating extraction shapes into the UV or thermally curable resin.

43. The method of claim 29, wherein forming one or both of the first and the second lightguides comprises attaching a layer of extraction features to a light guiding layer.

44. The method of claim 29, wherein one or more of the first lightguide, the second lightguide and the interfacial layer are disposed on a roll.

45. A method of making a dual lightguide subsystem, comprising:
unwinding a first lightguide layer from an input roll;
disposing an interfacial layer on the first lightguide layer; and
disposing one or more second light guides on the interfacial layer to form the dual lightguide roll good.

46. The method of claim 45, wherein disposing the one or more second lightguides on the interfacial layer comprising disposing multiple discrete second lightguides on the interfacial layer.

47. The method of claim 45, wherein disposing the one or more second lightguides on the interfacial layer comprises disposing a second lightguide layer on the interfacial layer.

48. The method of claim 47, further comprising selecting at least one of the first lightguide layer, the second lightguide layer and the interfacial layer to include properties that retain substantial flatness of the dual lightguide roll good.

49. A method of making a dual lightguide subsystem, comprising:
unwinding an interfacial layer from an input roll;
disposing one or more first lightguides on a first surface of the interfacial layer; and
disposing one or more second lightguides on a second surface of the interfacial layer to form the dual lightguide roll good.

50. A system, comprising:
a dual lightguide subsystem, comprising:
a first lightguide layer having an output surface, a back surface, and at least one input edge;
a second lightguide having an output surface, a back surface, and at least one input edge;
an interfacial layer arranged between the first lightguide and the second lightguide; and
a light source configured to input light into at least one of the input edge of the first lightguide and the input edge of the second lightguide;
a first display panel arranged along the output surface of the first lightguide; and
a second display panel arranged along the output surface of the second lightguide.

51. The system of claim 50, wherein one or both of the first display panel and the second display panel are liquid crystal display panels.

52. The system of claim 50, further comprising computer circuitry coupled to the dual display, wherein the dual display is configured to provide primary and secondary displays for a computer.

53. The system of claim 50, further comprising circuitry configured to transmit and receive voice data via a cellular telecommunications network, wherein the dual display is configure to provide primary and secondary displays for a cellular telephone.
